(19) United States
(12) Patent Application Publication
(10) Pub. No.: US 2024/0317002 A1
(43) Pub. Date: Sep. 26, 2024

(54) UTILITY TRAILER

(71) Applicant: Brent ODENBACH, Onoway (CA)

(72) Inventor: Brent ODENBACH, Onoway (CA)

(21) Appl. No.: 18/609,551

(22) Filed: Mar. 19, 2024

(30) Foreign Application Priority Data
Mar. 22, 2023 (CA) 3193773

(51) Int. Cl. B60D 1/44; B62D 63/06; B62D 63/08

(52) U.S. Cl. CPC B60D 1/44; B62D 63/062; B62D 63/08

(57) ABSTRACT

A utility trailer has a body from with a front end and a rear end. A hitch is connected to the front end of the body frame. A wheel axle is connected to the body frame and has a pair of wheels that extend below the body frame. A first load support and a second load support are provided and positioned on the body frame in parallel spaced relation to each other. The second load support is spaced from the first load support such that the second load support is positioned closer to the front end of the body frame than the first load support.

### FIELD OF THE DISCLOSURE

The present application relates generally to a utility trailer and more particularly to a utility trailer designed for use with all-terrain vehicles, utility terrain vehicles, and snowmobile type machines.

### BACKGROUND

This section provides background information to facilitate a better understanding of the various aspects of the invention. It should be understood that the statements in this section of this document are to be read in this light, and not as admissions of prior art.

All-terrain vehicles, utility terrain vehicles, and snowmobile type machines are often used for recreational purposes, work purposes (such as on a farm) and for moving in terrain unsuitable for regular automotives. Small trailers can be attached to all-terrain vehicles, utility terrain vehicles, and/or snowmobile type machines to allow for transport of tools and objects from one place to another without the use of a larger conventional utility trailer towed by an automotive. Examples of use of small trailers include transporting a canoe, boat, or paddle boards through the bush to get to a remote lake, transporting game from a hunt, or transporting tools and materials to camping sites or building sites. The challenge with most small trailers is transporting them with the all-terrain vehicles, utility terrain vehicles, and/or snowmobile type machines and finding appropriate places to store them when not in use.

### BRIEF SUMMARY

There is provided a utility trailer. The utility trailer has a body frame with a front end and a rear end. A hitch is connected to the front end of the body frame and a wheel axle is connected to the body frame. The wheel axle has a pair of wheels that extend below the body frame. A first load support and a second load support are positioned on the body frame in parallel spaced relation to each other. The second load support is spaced from the first load support such that the second load support is positioned closer to the front end of the body frame than the first load support.

In one embodiment, the hitch is connected to the front end of the body frame by a hitch telescoping body. The hitch telescoping body is movable relative to the body frame. The hitch telescoping body is locked in position relative to the body frame by a locking mechanism.

In one embodiment, the locking mechanism includes at least one body frame aperture extending through the body frame, at least one hitch aperture extending through the hitch telescoping body and corresponding to the at least one body frame aperture, and a removable pin extending through at least one of the at least one body frame aperture and at least one of the at least one hitch aperture to prevent movement of the hitch telescoping body relative to the body frame.

In one embodiment, a stop is positioned on a first end and a second end of each of the first load support and the second load support. The stop prevents an object from sliding off the first end or the second end of the first load support and the second load support.

In one embodiment, the first load support and the second load support are each comprised of three parts: a first side part, a center part, and a second side part. The first side part and the second side part are pivotable relative to the center part.

In one embodiment, the first load support and the second load support each have a vertical attachment, each of the vertical attachments are connected to a vertical connection on the body frame.

In one embodiment, the vertical attachment is removably attachable to the vertical connection on the body frame, the vertical attachment being locked in position on the vertical connection on the body frame by a load support locking mechanism.

In one embodiment, the vertical attachment telescopes relative to the vertical connection. The vertical attachment being locked in position relative to the vertical connection by the load support locking mechanism.

In one embodiment, the load support locking mechanism has at least one vertical attachment aperture extending through the vertical attachment, at least one vertical connection aperture extending through the vertical connection and corresponding to the at least one vertical attachment aperture, and a removable support pin extending through at least one of the at least one vertical attachment aperture and at least one of the at least one vertical connection aperture to prevent movement of the vertical connection relative to the vertical attachment.

In one embodiment, the pair of wheels are fixed direction wheels.

In one embodiment the utility trailer is disassemblable such that the hitch, the wheel axle, the first load support, and the second load support are removably attached to the body frame.

In one embodiment, the wheel axle is positioned adjacent the rear end of the frame body.

In one embodiment, the first load support is positioned adjacent the rear end of the body frame.

In one embodiment, the body frame is a straight bar. The straight bar is positioned perpendicular to the first load support and the second load support.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a utility trailer

FIG. 2 is a perspective view of the utility trailer of FIG. 1 with telescopic and pivoting arms repositioned.

FIG. 3 is a front elevation view of the utility trailer.

FIG. 4 is a rear elevation view of the utility trailer.

FIG. 5 is a top plan view of the utility trailer.

FIG. 6 is a bottom plan view of the utility trailer.

FIG. 7 is a side elevation view, partially in section, of the utility trailer.

### DETAILED DESCRIPTION OF THE PREFERRED EMBODIMENTS

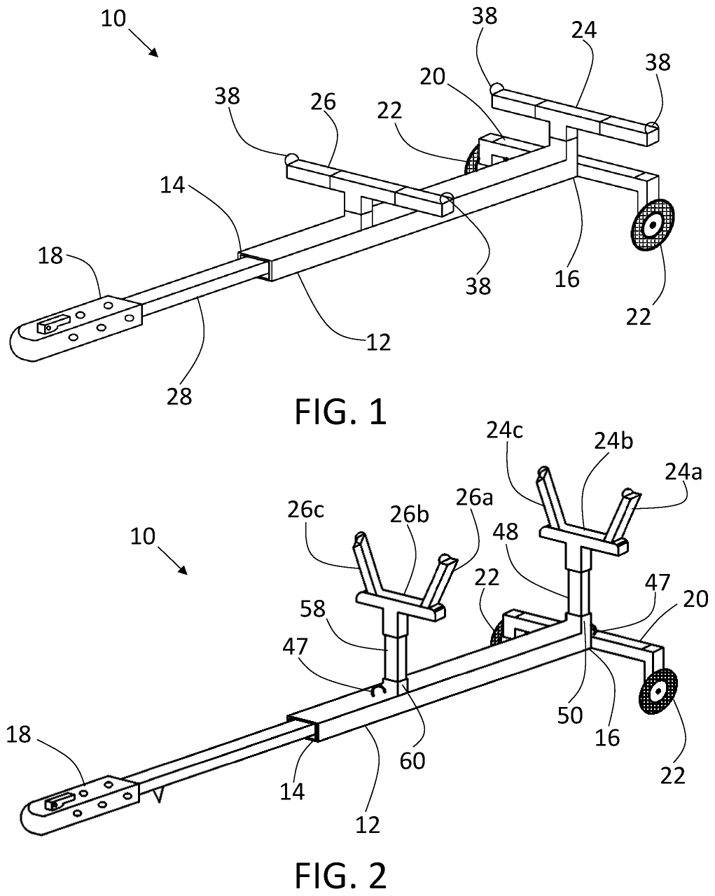

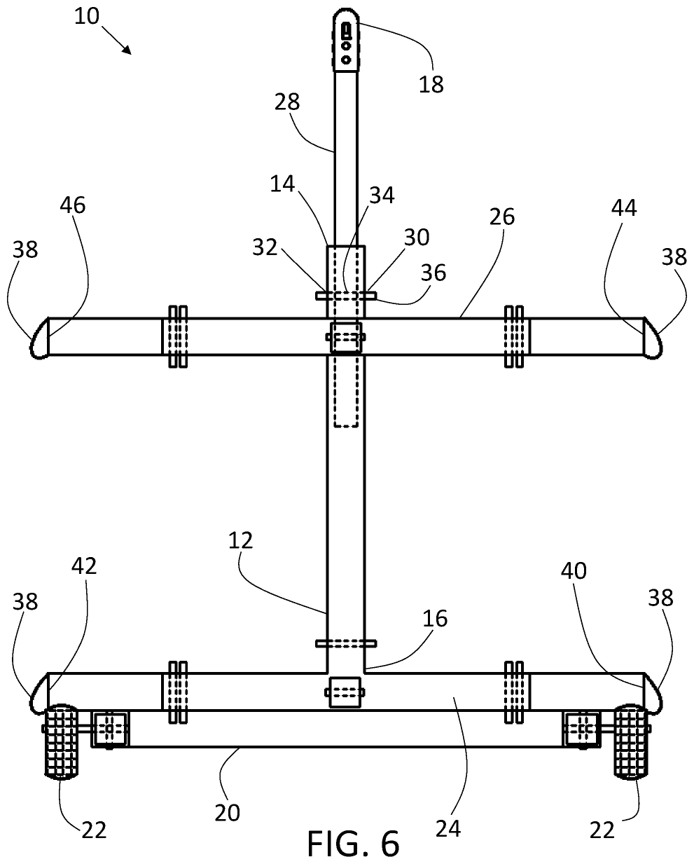

A utility trailer, generally identified by reference numeral 10, will now be described with reference to FIG. 1 through FIG. 7.

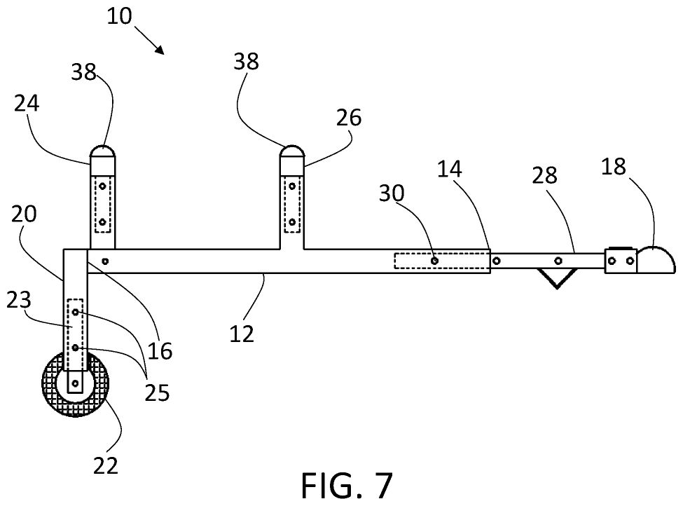

Referring to FIG. 1, a utility trailer 10 has a body frame 12 that has a front end 14 and a rear end 16. A hitch 18 is connected to front end 14 of body frame 12. In the embodiment shown, body frame 12 is a straight bar, however it will be understood by a person skilled in the art that body frame 12 may be any suitable shape and may incorporate multiple support bars. A wheel axle 20 is connected to body frame 12. Wheel axle 20 has a pair of wheels 22 that extend below body frame 12. Wheels 22 support body frame 12 on the ground and permit movement of utility trailer 10. Wheels 22 are preferably fixed direction wheels such that wheels 22 do not turn from side to side. This helps to ensure that utility trailer 10 follows a tow vehicle when in use. In the embodiment shown, wheel axle 20 is positioned at rear end 16 of body frame 12. It will be understood by a person skilled in the art that wheel axle 20 may be positioned at or adjacent rear end 16 or anywhere along body frame 12 that allows for proper balance of body frame 12. If body frame 12 slopes downwards from hitch 18 to rear end 16, wheel axle 20 must be positioned close enough to rear end 16 to prevent rear end 16 from contacting the ground. If wheel axle 20 is placed too close to front end 14 and hitch 18, utility trailer 10 may become unbalanced. Referring to FIG. 7, wheels 22 may have telescopic connections 23 with locking pins 25 to allow the height of utility trailer 10 to be raised or lowered. Extra room between the ground and body frame 12 can be beneficial where a road or terrain on which utility trailer 10 is traveling is bumpy, uneven, or difficult. It may also be beneficial to accommodate different sized towing vehicles. Referring to FIG. 1, a first load support 24 and a second load support 26 are positioned on body frame 12 in parallel spaced relation to each other and perpendicular to the straight bar of body frame 12. Second load support 26 is spaced from first load support 24 such that second load support 26 is positioned closer to front end 14 of body frame 12 than first load support 24. In the embodiment shown, first load support 24 is positioned adjacent rear end 16 of body frame 12. It may be beneficial for first load support 24 and wheel axle 20 to be positioned adjacent each other on body frame 12 to provide greater support for objects positioned on first load support 24.

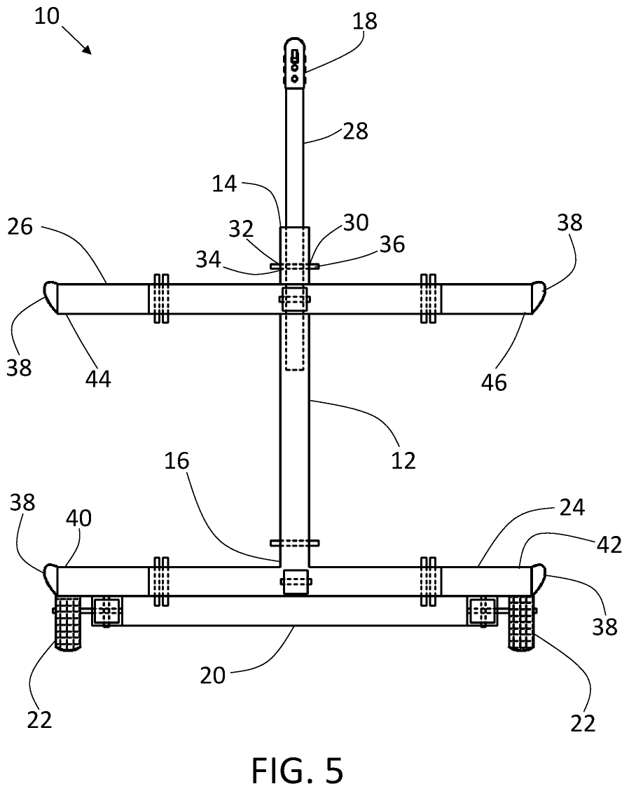

In the embodiment shown in FIG. 5 through FIG. 7, hitch 18 is connected to front end 14 of body frame 12 by a hitch telescoping body 28. Hitch telescoping body 28 is movable relative to body frame 12 and is lockable into position relative to body frame 12 by a locking mechanism 30. In the embodiment shown, at least a portion of front end 14 of body frame 12 is hollow and accepts hitch telescoping body 28 within the hollow body frame 12. However, it will be understood by a person skilled in the art that hitch telescoping body 28 could slide over front end 14 of body frame 12 or could slide against an outer side of body frame 12. Locking mechanism 30 may include at least one body frame aperture 32 that extends through body frame 12 and at least one hitch aperture 34 that extends through hitch telescoping body 28 and corresponds to the at least one body frame aperture 32. At least one removable pin 36 extends through at least one of body frame apertures 32 and at least one of hitch apertures 34 to prevent movement of hitch telescoping body 28 relative to body frame 12. A person of skill in the art will understand that other types of locking mechanisms may be used, including but not limited to, clamps, ties, friction fits, shoulders, and any other suitable mechanism known to a person skilled in the art.

Stops 38 may be positioned on a first end 40 and a second end 42 of first load support 24 and first end 44 and second end 46 of second load support 26. Stops 38 help to prevent an object resting on first load support 24 and second load support 26 from sliding off first ends 40 and 44 and second ends 42 and 46. Stops 38 may also act as load securement tie-downs. While not required, tie down rings 47 may be positioned on body frame 12 and may act as anchors when tying an object to utility trailer 10. Objects may also be tied directly to body frame 12, first load support 24, second load support 26, or any other part of utility trailer 10 suitable for such purpose. It will be understood that tie down rings 47 may also be positioned on first load support 24, second load support 26, hitch 18, hitch telescoping body 28, and/or wheel axle 20.

In one embodiment, utility trailer 10 may be disassembled for storage or travel when not in use. Hitch telescoping body 28, wheel axle 20, first load support 24, and second load support 26 are separated from body frame 12. Wheels 22 may also be removable from wheel axle 20. The pieces of utility trailer 10 may be moved in the disassembled form in a vehicle and later assembled for use. Referring to FIG. 2, in helping to reduce storage space, first load support 24 and second load support 26 may be comprised of three separate parts. First load support 24 may include a first side part 24a, a center part 24b, and a second side part 24c. The first side part 24a and the second side part 24c are able to pivot relative to center part 24b such that first load support 24 takes up less space lengthwise. Second load support 26 may include a first side part 26a, a center part 26b, and a second side part 26c. The first side part 26a and the second side part 26c are able to pivot relative to center part 26b such that second load support 26 takes up less space lengthwise. In the embodiment shown, first side parts 24a and 26a and second side parts 24c and 26c pivot upwards relative to center parts 24b and 26b. This has the benefit that the weight of an object supported on first load support 24 and/or second load support 26 will act to maintain first side part 24a, center part 24b, and second side part 24c in alignment and first side part 26a, center part 26b, and second side part 26c in alignment. If first side parts 24a and 26a and second side parts 24c and 26c pivot in other directions relative to center parts 24b and 26b, locking mechanisms are required to hold the parts in appropriate alignment when in use. As can be seen in the embodiments shown, locking pins through apertures are utilized to hold the three parts of first load support 24 and second load support 26 in alignment during use. In one embodiment, first side parts 24a and 26a and second side parts 24c and 26c pivot upwards 0 to 90 degrees relative to center parts 24b and 26b and may be held in place by locking pins at predetermined angles such as 90 degrees or 45 degrees, as examples only. Locking at 45 degrees relative to center parts 24b and 26b could be beneficial where the object being supported by the first load support 24 and the second load support 26 are narrower in width than the length of first load support 24 and second load support 26.

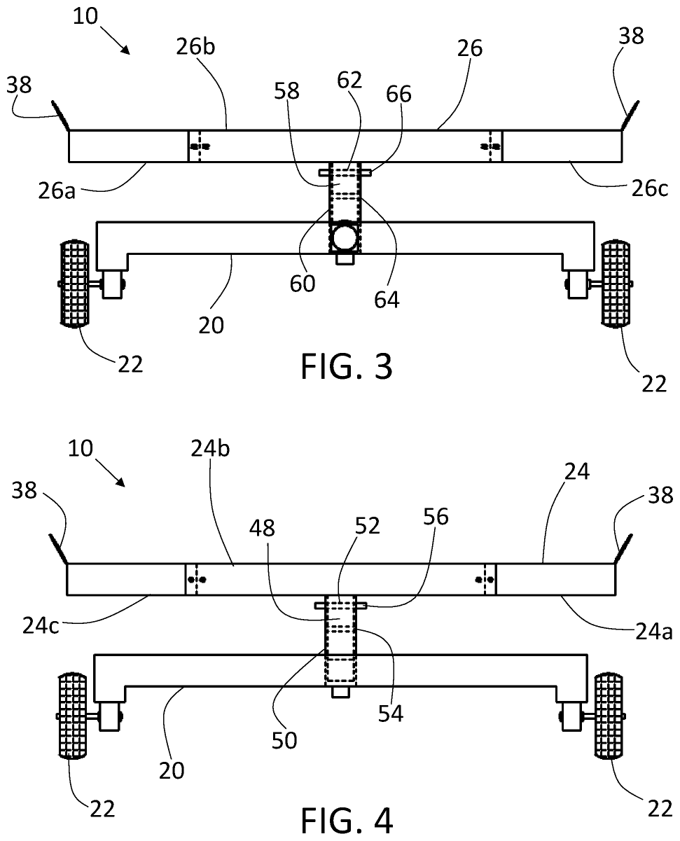

Referring to FIG. 4, to aid in disassembly and reassembly, first load support 24 may have a vertical attachment 48 that extends downwards perpendicular to center part 24b that connects to a vertical connection 50 on body frame 12. In the embodiment shown, vertical attachment 48 may telescope relative to vertical connection 50 to change the height of first load support 24 relative to body frame 12. Vertical attachment 48 may be locked in position relative to vertical connection 50 by any method known to a person skilled in the art. In the embodiment, vertical attachment apertures 52 are aligned with vertical connection apertures 54 and a removable support pin 56 extends through vertical attachment apertures 52 and vertical connection apertures 54 to lock first load support 24 in position relative to body frame 12. Referring to FIG. 3, second load support 26 may also have a vertical attachment 58 that extends downwards perpendicular to center part 26b that connects to a vertical connection 60 on body frame 12. In the embodiment shown, vertical attachment 58 may telescope relative to vertical connection 60 to change the height of second load support 26 relative to body frame 12. It will be understood by a person skilled in the art that the height of first load support 24 and second load support 26 relative to body frame 12 does not have to be the same. In some instances, it may be beneficial for one of first load support 24 or second load support 26 to be lower. This may assist with potential balance issues where one end of an object being transported is heavier than the opposite end. Vertical attachment 58 may be locked in position relative to vertical connection 60 by any method known to a person skilled in the art. In the embodiment shown, vertical attachment apertures 62 are aligned with vertical connection apertures 64 and a removable support pin 66 extends through vertical attachment apertures 62 and vertical connection apertures 64 to lock second load support 26 in position relative to body frame 12.

Utility trailer 10 can be disassembled and placed in a vehicle or on an all-terrain vehicle, utility terrain vehicle, and/or snowmobile type machine for transport purposes. In the embodiment shown where lock pins are used to hold pieces together, utility trailer 10 can be reassembled without the use of tools and hitched up for use when needed. Utility trailer 10 can later be disassembled again and stored for later use. Utility trailer 10 provides users with the ability to quickly assemble and disassemble a trailer as needed. In the disassembled form, utility trailer 10 takes up a small amount of space which allows for easier transport and storage when compared to conventional trailers.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A utility trailer, comprising:
a body frame having a front end and a rear end;
a hitch is connected to the front end of the body frame;
a wheel axle is connected to the body frame, the wheel axle having a pair of wheels that extend below the body frame;
a first load support and a second load support positioned on the body frame in parallel spaced relation to each other, the second load support being spaced from the first load support such that the second load support is positioned closer to the front end of the body frame than the first load support.

2. The utility trailer of claim 1 wherein the hitch is connected to the front end of the body frame by a hitch telescoping body, the hitch telescoping body being movable relative to the body frame, the hitch telescoping body being locked in position relative to the body frame by a locking mechanism.

3. The utility trailer of claim 2 wherein the locking mechanism comprises at least one body frame aperture extending through the body frame, at least one hitch aperture extending through the hitch telescoping body and corresponding to the at least one body frame aperture, and a removable pin extending through at least one of the at least one body frame aperture and at least one of the at least one hitch aperture to prevent movement of the hitch telescoping body relative to the body frame.

4. The utility trailer of claim 1 wherein a stop is positioned on a first end and a second end of each of the first load support and the second load support, the stop preventing an object from sliding off the first end or the second end of the first load support and the second load support.

5. The utility trailer of claim 1 wherein the first load support and the second load support are each comprised of three parts, a first side part, a center part, and a second side part, the first side part and the second side part being pivotable relative to the center part.

6. The utility trailer of claim 1 wherein the first load support and the second load support each have a vertical attachment, each of the vertical attachment being connected to a vertical connection on the body frame.

7. The utility trailer of claim 6 wherein the vertical attachment is removably attachable to the vertical connection on the body frame, the vertical attachment being locked in position on the vertical connection on the body frame by a load support locking mechanism.

8. The utility trailer of claim 7 wherein the vertical attachment telescopes relative to the vertical connection, the vertical attachment being locked in position relative to the vertical connection by the load support locking mechanism.

9. The utility trailer of claim 8 wherein the load support locking mechanism comprises at least one vertical attachment aperture extending through the vertical attachment, at least one vertical connection aperture extending through the vertical connection and corresponding to the at least one vertical attachment aperture, and a removable support pin extending through at least one of the at least one vertical attachment aperture and at least one of the at least one vertical connection aperture to prevent movement of the vertical connection relative to the vertical attachment.

10. The utility trailer of claim 1 wherein the pair of wheels are fixed direction wheels.

11. The utility trailer of claim 1 wherein the utility trailer is disassemblable such that the hitch, the wheel axle, the first load support, and the second load support are removably attachable to the body frame.

12. The utility trailer of claim 1 wherein the wheel axle is positioned adjacent the rear end of the frame body.

13. The utility trailer of claim 1 wherein the first load support is positioned adjacent the rear end of the body frame.

14. The utility trailer of claim 1 wherein the body frame is a straight bar, the straight bar being positioned perpendicular to the first load support and the second load support.
